(19) United States
(12) Patent Application Publication
(10) Pub. No.: US 2024/0420371 A1
(43) Pub. Date: Dec. 19, 2024

(54) A METHOD, SOFTWARE PRODUCT AND SYSTEM FOR GNSS-DENIED NAVIGATION

(71) Applicant: SAAB AB, Linköping (SE)

(72) Inventor: Astrid LUNDMARK, Linköping (SE)

(21) Appl. No.: 18/704,221

(22) PCT Filed: Nov. 7, 2022
(86) PCT No.: PCT/SE2022/051028

§ 371 Date: Apr. 24, 2024

(30) Foreign Application Priority Data
Nov. 9, 2021 (SE) 2100171-4

(51) Int. Cl. G06T 7/73; G01C 21/00

(52) U.S. Cl. CPC G06T 7/75; G01C 21/005; G06T 2207/10028; G06T 2207/30244

(57) ABSTRACT

The present disclosure relates to a method for determining a pose. The method (100) comprises capturing (110), utilizing at least one camera (311), at least a first image (220) at a first pose and a second image (230) at a second pose; obtaining (120) digital surface model, DSM, data (210), wherein said DSM data (210) represents a part of Earth's surface corresponding to said first pose and said second pose; determining (130) at least one set of hypothetical camera poses, wherein each set of hypothetical camera poses is a candidate for the first and the second poses; calculating (140) a matching score for each set of hypothetical camera poses based on matching said first image (220) and second image (230), wherein matching is based on said obtained DSM data (210) and said set of hypothetical camera poses; and determining (150) the first pose based on the matching score of the at least one set of hypothetical camera poses.

### TECHNICAL FIELD

The present disclosure relates to navigation and pose estimation in an environment wherein GNSS support is compromised.

### BACKGROUND

Historically the challenge of determining one's position and bearing was solved by observing the surrounding environment and, if available, identifying some known objects from which one's own pose could be determined.

In modern times several types of pose determining systems are arranged to receive information via wireless communication from remote man-made systems in order to determine a pose. The received information may be intended specifically for said pose determining system, or may be part of a one-way communication intended for a large number or receivers, such as signals from the Global Positioning System (GPS).

Pose determining systems requiring information obtained wirelessly from a remote sender may fail to function if the sender stops functioning, the system's receiver stops functioning and/or other electromagnetic radiation interferes with the sent information at the receiver, such as interfering electromagnetic radiation due to electronic warfare. There is a need for improved systems for determining pose that function independently of information from remote systems.

### SUMMARY

One object of the invention is to improve GNSS-denied navigation and pose estimation.

This has in accordance with the present disclosure been achieved by means of a computer implemented method for determining a pose. The method comprises capturing, utilizing at least one camera, at least a first image at a first pose and a second image at a second pose; obtaining digital surface model, DSM, data, wherein said DSM data represents a part of Earth's surface corresponding to said first pose and said second pose; determining at least one set of hypothetical camera poses, wherein each set of hypothetical camera poses is a candidate for the first and the second poses; calculating a matching score for each set of hypothetical camera poses based on matching said first image and second image, wherein matching is based on said obtained DSM data and said set of hypothetical camera poses; and determining the first pose based on the matching score of the at least one set of hypothetical camera poses.

This has the advantage of allowing determining a pose useful for navigation by taking two or more images of the terrain. This may further allow for image capture based navigation with a decreased computational cost.

The term GNSS-denied relates to an environment wherein one or more global navigation satellite systems, such as GPS, are unavailable.

In some examples of the method, capturing the first image and the second image comprises obtaining a relative pose difference between said first pose and said second pose; and determining at least one set of hypothetical camera poses is based on said relative pose difference. In some of these examples, obtaining the relative pose difference between the first pose and the second pose comprises determining the relative pose difference utilizing navigation information obtained from pose change tracking means. In some of these examples said pose change tracking means comprise an inertial navigation system (INS), an inertial measurement unit (IMU), and/or a system utilizing a series of images, lidar and/or radar measurements to track pose change.

This has the advantage of allowing more refined sets of hypothetical camera poses to be defined, thereby reducing computational cost and/or accuracy in determining the first pose.

In some examples of the method, capturing the first image and the second image comprises obtaining pose information for said at least first pose and/or said second pose, wherein pose information comprises a pose, a position and/or a bearing; and determining at least one set of hypothetical camera poses is based on said pose information. In some of these examples matching said first image and said second image is based on said pose information.

This has the advantage of allowing more refined sets of hypothetical camera poses to be defined, thereby reducing computational cost and/or accuracy in determining the first pose. This further has the advantage of allowing some pose values of the first pose to be obtained during image capture.

In some examples of the method, determining at least one set of hypothetical camera poses comprises determining at least two sets of hypothetical camera poses. In some of these examples, determining the first pose based on the matching scores of said at least two sets of hypothetical camera poses further comprises determining a probability density function for the determined first pose.

This has the advantage of allowing additional sets of hypothetical camera poses to contribute to a probability density function for the determined first pose. This further has the advantage of allowing the use of sets of hypothetical camera poses in a sparse grid and utilizing interpolation to determine said first pose.

In some examples of the method, determining at least one set of hypothetical camera poses comprises obtaining sensor information and/or a previously determined first pose, and determining at least one set of hypothetical camera poses is based on said sensor information and/or said previously determined first pose.

This has the advantage of allowing said previously determined first pose and a maximum speed of a camera platform comprising said camera to be used to exclude the first pose form being outside a corresponding radius of the previously determined first pose. This further has the advantage of allowing said previously determined pose and sensor information comprising camera platform speed to be used to exclude the first pose form being outside a typically smaller corresponding radius.

In some examples of the method, capturing at least said first image and said second image comprises simultaneously capturing a plurality of the at least said first image and said second image utilizing at least two cameras.

This has the advantage of allowing the relative pose difference between the first pose and the second pose to be known based on the mounting of the cameras, thereby reducing the requirements for equipment on-board the camera platform.

The present disclosure also relates to a computer program product comprising a non-transitory computer-readable storage medium having thereon a computer program comprising program instructions. The computer program being loadable into a processor and configured to cause the processor to perform the method according to what is presented herein.

The computer program corresponds to the steps performed by the method discussed above and has all the corresponding associated effects and advantages of the disclosed method.

The present disclosure also relates to a system for determining a pose of a camera. The system comprises a set of sensors, a computer and a memory storage, wherein the set of sensors comprising pose change tracking means and at least one camera. Said computer is arranged to
control said at least one camera to capture at least a first image at a first pose and a second image at a second pose;
determine a relative pose difference between said first pose and said second pose based on navigation information obtained from said pose change tracking means;
obtain digital surface model, DSM, data from said memory storage, wherein said DSM data corresponds to a part of Earth's surface corresponding to said first pose and said second pose,
determine at least one set of hypothetical camera poses, wherein each set of hypothetical camera poses is a candidate for the first and the second poses;
calculate a matching score for each set of hypothetical camera poses based on matching said first image and second image, wherein matching is based on said obtained DSM data and said set of hypothetical camera poses; and
determine the first pose based on the matching score of the at least one set of hypothetical camera poses.

This has the advantage of allowing the first pose to be determined utilizing input from a camera and pose change tracking means, such as an inertial navigation system, INS. This further has the advantage of allowing calculation of the first pose for low computational cost, as for each set of hypothetical camera poses the parts of the images to be compared may be defined by simple geometrical relationships.

In some examples said pose change tracking means comprise an inertial navigation system (INS), an inertial measurement unit (IMU), and/or a system utilizing a series of images, lidar and/or radar measurements to track pose change.

In some examples of the system, the set of sensors (310) comprises at least two cameras, and said set of sensors (310) is arranged to simultaneously capture at least two images with at least partial overlap.

This has the advantage of allowing the relative pose difference of simultaneously captured images to be known based on the camera mounting of said at least two cameras.

### BRIEF DESCRIPTION OF THE DRAWINGS

FIG. 1 shows schematically a method for GNSS-denied navigation.

FIG. 2a-c depicts schematically digital surface model data and captured images.

FIG. 3 shows schematically a system for GNSS-denied navigation.

FIG. 4 depicts schematically a data processing unit comprising a computer program product.

### DETAILED DESCRIPTION

Throughout the figures, same reference numerals refer to same parts, concepts, and/or elements. Consequently, what will be said regarding a reference numeral in one figure applies equally well to the same reference numeral in other figures unless explicitly stated otherwise.

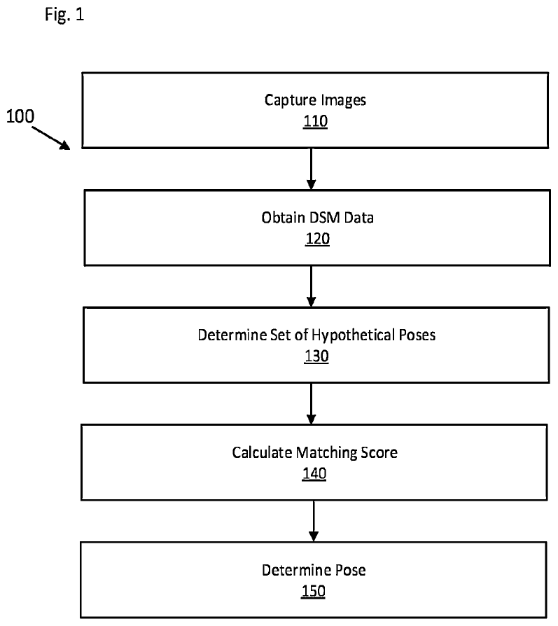

FIG. 1 shows schematically a method for GNSS-denied navigation. The computer implemented method 100 comprises
capturing 110, utilizing at least one camera, at least a first image at a first pose and a second image at a second pose;
obtaining 120 digital surface model, DSM, data, wherein said DSM data represents a part of Earth's surface corresponding to said first pose and said second pose;
determining 130 at least one set of hypothetical camera poses, wherein each set of hypothetical camera poses is a candidate for the first and the second poses;
calculating 140 a matching score for each set of hypothetical camera poses based on matching said first image and second image, wherein matching is based on said obtained DSM data and said set of hypothetical camera poses; and
determining 150 the first pose based on the matching score of the at least one set of hypothetical camera poses.

The term GNSS-denied relates to an environment wherein one or more global navigation satellite systems, such as GPS, are unavailable.

The term camera is to be understood as any sensor or set of sensors arranged to provide an image.

The term first pose and second pose relates to poses at which images were captured. Typically said poses relate to camera fields of view that each have line of sight to at least some parts of Earth's surface.

The term set of hypothetical camera poses relates to a plurality of hypothetical camera poses, wherein said set of hypothetical camera poses comprises for each pose from which an image was captured a candidate hypothetical camera pose. Typically a plurality of sets of hypothetical camera poses are determined, wherein each set of hypothetical camera poses represents one candidate state for how said images were captured.

The expression “determining at least one set of hypothetical camera poses” is to be understood as determining one candidate pose for each captured image. The at least one set of hypothetical camera poses may be determined at the same time, or may be determined in an iterative process after each matching score is calculated.

The expression “DSM data represents a part of Earth's surface corresponding to said first pose and said second pose” is to be understood as the DSM data describing a part of Earth's surface that is expected to be at least partially in the field of view of cameras at said poses. Typically, the part of Earth's surface represented by DSM data is so large that the poses may be assumed to be above said surface part, such as the surface of a state or country. Typically, the part of Earth's surface represented by DSM data includes height information taking vegetation and man-made structures into account. Typically, DSM data is predetermined DSM data, such DSM data that is part of an established model of Earth's surface.

In some examples, obtaining 120 DSM data comprises obtaining predetermined DSM data.

In some examples the method 100, capturing 110 at least the first image and the second image comprises obtaining at least one camera calibration, and wherein calculating 140 the matching score for each set of hypothetical camera poses is based on said at least one camera calibration. Typically, camera calibration is known prior to initiating the method 100.

In some examples the method 100, capturing 110 at least the first image and the second image comprises obtaining a relative pose difference between said first pose and said second pose; and determining 130 at least one set of hypothetical camera poses is based on said relative pose difference. In some of these examples obtaining the relative pose difference between the first pose and the second pose comprises determining the relative pose difference utilizing navigation information obtained from pose change tracking means. In some of these examples said pose change tracking means comprise an inertial navigation system (INS), an inertial measurement unit (IMU), and/or a system utilizing a series of images, lidar and/or radar measurements to track pose change.

The term relative pose difference relates to differences between the first pose and the second pose from which the images were captured. For three or more images each captured from a different pose, relative pose difference typically relates to differences between at least two of said three or more poses. Relative pose difference may consist of rotation values and translation values relative to the first pose and/or a bearing. It is to be understood that, if the first pose and the second pose have a known relative pose difference, then determining a hypothetical camera pose being a candidate for said first pose also determines a set of hypothetical camera poses being a candidate for said first pose and the second pose.

The term pose change tracking means relates to devices arranged to estimate changes in pose overtime based on measurables, such as accelerations, sensor reading of the external environment, e.g. a series of images or radar measurements, or other measurables suitable for determining pose change. The estimate changes in pose over time is typically the pose of an object the pose change tracking means is comprised within, or a part thereof. Pose change tracking means may comprise an INS/IMU. Pose change tracking means may comprise a system arranged to perform image processing on a series of images, lidar and/or radar measurements to estimate a relative displacement.

The term navigation information from an inertial navigation system relates to translational acceleration and/or angular acceleration measurements of inertial navigation systems. Typically, navigation information from inertial navigation systems may be utilized to determine a down direction.

It is to be understood that upon “determining 150 the first pose” it typically follows that the second pose of the second image capture is determined, due to a known or an assumed relative pose difference.

In some examples the method 100, comprises determining a down direction based on said navigation information obtained from the pose change tracking means, and wherein determining 130 at least one set of hypothetical camera poses is based on said determined down direction. In some of these examples, determining 150 the first pose is based on said determined down direction.

In some examples the method 100, capturing 110 the first image and the second image comprises obtaining pose information for said at least first pose and/or said second pose, wherein pose information comprises a pose, a position and/or a bearing; and determining 130 at least one set of hypothetical camera poses is based on said pose information. In some of these examples, matching said first image and said second image is based on said pose information. Pose information may comprise partial pose, position and/or bearing information, such as a height or pitch angle.

In some examples the method 100 comprises capturing 110 at least three images at different poses, and obtaining a relative pose difference between said images. Some of these examples comprises capturing 110 and obtaining a relative pose difference between at least five, at least ten, at least fifty, or at least two hundred captured images.

In some examples of the method 100, determining 130 said at least one set of hypothetical camera poses comprises obtaining sensor information and/or a previously determined pose, and determining 130 said at least one set of hypothetical camera poses based on said obtaining sensor information and/or said previously determined pose. In some of these examples, determining 130 said at least one set of hypothetical camera poses comprises utilizing dead reckoning for the previously determined pose. Sensor information may comprise the speed of a camera platform, such as a flying platform.

In some examples of the method 100, determining 130 said at least one set of hypothetical camera poses comprises determining at least two sets of hypothetical camera poses. Some examples of the method 100 comprises determining a number of sets of hypothetical camera poses that is at least three, at least five, at least ten, at least fifty, or at least two hundred.

In some examples of the method 100, matching said first image and second image is based on said obtained DSM data and said set of hypothetical camera poses; wherein corresponding image regions in said images are detected based on said obtained DSM data and said hypothetical camera pose; and wherein matching is based on comparing said detected corresponding image regions. In some of these examples, if camera calibration is known, the corresponding image regions in said images may be defined by said obtained DSM data and said set of hypothetical camera poses.

In some examples of the method 100, upon calculating 140 the matching score of a first set of hypothetical camera poses, determining a second set of hypothetical camera poses based on the calculated matching score of said first set of hypothetical camera poses. In some of these examples, each set of hypothetical camera poses subsequent to the first set of hypothetical camera poses is determined iteratively based on calculated matching scores of one or more previous sets of hypothetical camera poses. In some of these examples, at least one set of hypothetical camera poses is determined based on interpolation of a plurality of previous set of hypothetical camera poses and their matching scores. In some of these examples, utilizing previous sets of hypothetical camera poses is based on one or more criteria, such as the previous set of hypothetical camera poses being calculated less than a predetermined amount of time ago.

In some examples of the method 100, calculating 140 each matching score comprises determining at least one set of corresponding pixel coordinates and/or image regions in said first image and said second image. In some of these examples, said set of corresponding pixel coordinates and/or image regions are compared utilizing feature detection and/or phase correlation. The set of corresponding pixel coordinates and/or image regions in said at least two captured images may be determined for each set of hypothetical camera poses by utilizing the geometric relationship between the DSM data and the set of hypothetical camera poses. In some of these examples, the set of corresponding pixel coordinates and/or image regions relates to view angles from each of said poses towards the same part of a surface described by the DSM data, wherein said part of the surface is in the field of view related to cameras at said two poses. For a set of hypothetical camera poses that correspond to the poses said two images were capture from and wherein said captured images do have an overlap depicting terrain, it is expected that the determined corresponding image regions in the two images represent said overlapping depicted terrain.

In some examples the determined set of corresponding pixel coordinates and/or image regions may be utilized as regions of interest for matching the at least two captured images. In some of these examples, matching is performed for image areas on and surrounding said determined set of corresponding pixel coordinates and/or image regions.

In some examples, the method 100 comprises calculating 140 matching scores for each of a plurality of set of hypothetical camera poses, and determining 150 the first pose based on the matching scores of said plurality of set of hypothetical camera poses comprises utilizing interpolation of said plurality of matching scores.

In some examples of the method 100, determining 150 the first pose based on the matching scores of said plurality of set of hypothetical camera poses further comprises determining a probability density function for the determined first pose. In some of these examples, a covariance matrix is determined for the determined first pose.

Each determined set of hypothetical camera poses comprises a plurality of poses wherein each pose is a candidate for the pose of one captured image. The set of hypothetical camera poses may be a candidate for two poses with a known relative pose difference, such that the set of hypothetical camera poses represents an assumed pose value for one of the two poses. Alternatively, the set of hypothetical camera poses may be a candidate for two poses with a known pose value for one pose, such that the set of hypothetical camera poses represents an assumed value for the relative pose difference between said two poses. It is to be understood that there exists a multitude of different possible combinations of known and assumed values relating to said poses that may be the basis for determining the at least one set of hypothetical camera poses.

In some examples the method 100, determining 130 at least one set of hypothetical camera poses comprises determining 130 at least four sets of hypothetical camera poses. In some of these examples, the number of determined sets of hypothetical camera poses is at least eight, at least twenty, at least fifty, or at least two hundred.

It is to be understood that a possible implementation of the method is to determine if an assumed pose is correct based on at least one criteria, wherein determining (130) at least one set of hypothetical camera poses comprises determining a set of hypothetical camera poses based on the assumed pose, and wherein determining (150) the first pose based on the matching score comprises determining the first pose to be a pose corresponding to the assumed pose if the at least one criteria is fulfilled. The at least one criteria may be to have a matching score above a predetermined value.

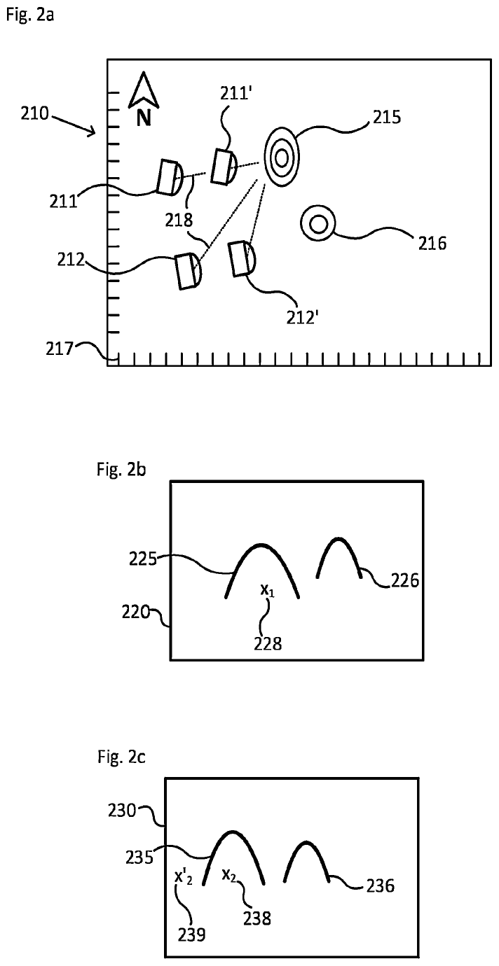

FIG. 2a-c depicts schematically digital surface model data and two captured images. FIG. 2a-c relate to an example which aims to explain how corresponding areas of a first image and a second image may be determined by utilizing said digital surface model data, and a set of hypothetical camera poses, wherein each set of hypothetical camera poses has a relative pose difference between hypothetical camera poses based on a known relative pose difference between the two images from capture. Image matching in the description of FIG. 1 may comprise comparing such determined corresponding areas to calculate a matching score for said set of hypothetical camera poses.

FIG. 2a depicts schematically a representation of digital surface model, DSM, data 210. For ease of reading, the term DSM data 210 is in the description of FIG. 2a used both for the data as such and the representation of the data. Said DSM data 210 comprises height information for a part of Earth's surface. In the example, said DSM data 210 describes two hills 215,216, visualized as height lines on a 2D map in FIG. 2a. The orientation and scale of said height information in said DSM data 210 is known, as visualized by a North Arrow and grid lines of a coordinate system 217 on the 2D map. In the example, said coordinate system 217 relating to said DSM data 210 is relatable to a global coordinate reference system, such as the geographic coordinate system, GCS, whereby determining a pose in relation to said DSM data 210 may also allow determining said pose in said GCS. In some examples, said DSM data 210 is georeferenced.

Typically, DSM data 210 describes a digital surface model or a part thereof, wherein said model is a three-dimensional representation of the heights of Earth's surface. In some examples the heights of Earth's surface includes the height of trees and/or buildings. The aforementioned set of hypothetical camera poses may be described in such a three-dimensional representation, and if camera calibration is known, each hypothetical camera pose corresponds to a field of view in the three-dimensional representation. In the example, the camera calibration and the relative pose difference between the first image and the second image is known, and each set of hypothetical camera poses comprises hypothetical camera poses with said relative pose difference. In the example, said digital surface model is a three-dimensional representation comprising a surface relating to the heights of the two hills 215,216, wherein said surface is described by the DSM data 210. Typically, DSM data 210 is predetermined DSM data, such as DSM data that is part of an established model of Earth's surface.

FIG. 2a depicts a first set of hypothetical camera poses and a second set of hypothetical camera poses overlaid on the 2D map representing the DSM data 210. The first set of hypothetical camera poses comprises a first pose 211 and a second pose 212, and the second set of hypothetical camera poses comprises a first pose 211′ and a second pose 212′.

FIG. 2b depicts schematically the first image 220 captured by digital camera. Said first image 220 depicts two hills 225,226 corresponding to the hills 215,216 represented in FIG. 2a.

FIG. 2c depicts schematically the second image 230 captured by digital camera. Said second image 230 depicts two hills 235,236 corresponding to the hills 215,216 represented in FIG. 2a.

Upon capture of the first image 220 and the second image 230, the poses during capture are typically not known in the coordinate system 217 of the DSM data 210. In the example, the camera calibration(s) during capture is known, the relative pose difference was obtained during capture of the first image 220 and the second image 230, and the two images 220,230 are known to have overlapping fields of view covering at least a part of Earth's surface. At least some of said part of Earth's surface seen in both images is comprised in the surface described by the DSM data 210. That is to say, that, for two captured images it is typically required for some area of Earth's surface to be seen in both images and described by the DSM data 210.

In the example in FIG. 2a-c, the first set of hypothetical camera poses 211,212 is substantially the poses the first image 220 and the second image 230 were captured at, and the second set of hypothetical camera poses 211′,212′ significantly deviates from the poses the first image 220 and the second image 230 were captured at.

Returning to FIGS. 2b and 2c, for each set of hypothetical camera poses a set of corresponding pixel coordinates and/or image regions in the first 220 and second image 230 may be determined based on said set of hypothetical camera poses and the DSM data 210. In the example, an image region 228 in the first image 220, marked x₁ in FIG. 2b, defines for each set of hypothetical camera poses a corresponding region in the second image 230. In this example, using the first set of hypothetical camera poses 211,212, results in an image region x₂ 238 in the second image 230 in FIG. 2c that depicts substantially the same part of the hill 215,225,235 as image region x₁ in the first image 220. Using the second set of hypothetical camera poses 211′,212′ results in the image region x′₂ 239 in the second image 230, which does not correspond to the same part of the hill 215,225,235 as image region x₁ in the first image 220. In the example with two images, line of sight from each hypothetical camera pose to one surface described by the DSM data 210 is typically required in order to determine said set of corresponding pixel coordinates and/or image regions in the images 220,230 for said set of hypothetical camera poses.

Note that the positions of the corresponding image regions x₂ 238 and x′₂ 239 in the second image 230 are in the example not determined based on pixel values or detected features in the first image 220 and the second image 230. Instead each marked image region 238,239 in the second image 230 relates to a view angle from the set of hypothetical camera poses towards the surface described by the DSM data 210 that matches the image region x₁ 228 in the first image 220. In the example, the first poses 211,211′ of both sets of hypothetical camera poses relate to substantially the same view angle towards the surface described by the DSM data 210 corresponding to the image region x₁ 228 in the first image 220, thus the difference between the marked image regions 238,239 in the second image 230 may be seen as visualized in the difference in view angle towards the surface described by the DSM data corresponding to the image region x₁ 228 relating to the second poses 212,212′. FIG. 2a comprises a representation of view angles 218 from each pose towards the surface described by the DSM data corresponding to the image region x₁ 228 in the first image 220. For some set of hypothetical poses, a corresponding image region may be determined to be outside of an image. A set of hypothetical poses with a majority of corresponding image regions located outside of the other image may indicate a significantly deviating set of hypothetical poses.

For each set of hypothetical camera poses said determined set of pixel coordinates and/or image regions in the first 220 and second image 230 may be compared in order to determine a matching score. In some examples, comparing comprises detecting similar features in and/or around the pixel coordinates and/or the image regions being compared. In some examples, said comparing comprises performing phase correlation. In the example, comparing of image region x₁ with image region x₂ is expected to give the first set of hypothetical camera poses 211,212 a relatively high matching score, and comparing image region x₁ with image region x′₂ is expected to give the second 211′,212′ relatively a lower matching score.

Determining corresponding pixel coordinates and/or the image regions based on a set of hypothetical camera poses may be performed for three or more images in a manner similar to the description of FIG. 2a-c. In case of obtaining overdetermined equation system for said corresponding pixel coordinates and/or the image regions least squares approximations may be utilized, alternatively corresponding pixel coordinates and/or the image regions may be determined for each relevant pair of images.

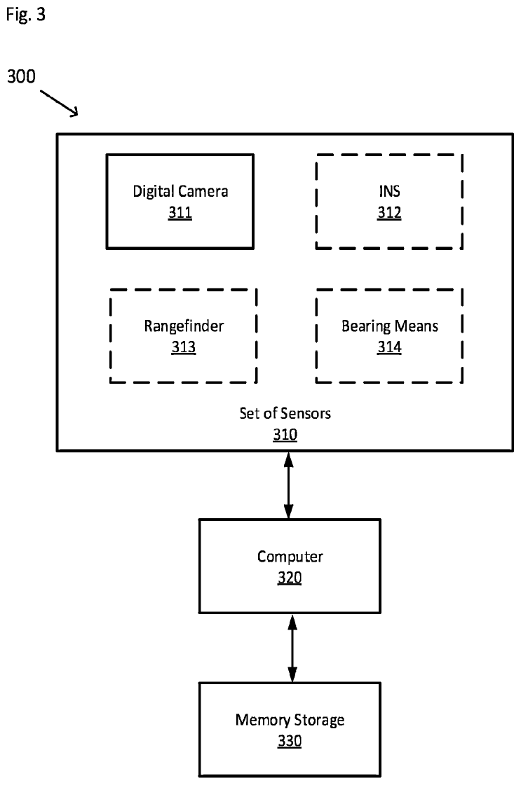

FIG. 3 shows schematically an example system for GNSS-denied navigation. The system 300 for determining a pose of a camera comprises a set of sensors 310, a computer 320 and a memory storage 330, wherein the set of sensors 310 comprising at least one camera 311. The computer 320 is connected to the set of sensors 310 and the memory storage 330. The memory storage 330 comprises digital surface model, DSM, data for at least part of Earth's surface.

The computer 320 is arranged to
control said at least one camera 311 to capture of at least a first image at a first pose and a second image at a second pose;
determine a relative pose difference between said first pose and said second pose;
obtain DSM data from said memory storage 330, wherein said DSM data corresponds to a part of Earth's surface corresponding to said first pose and said second pose;
determine at least one set of hypothetical camera poses based on the relative pose difference;
calculate for each determined set of hypothetical camera poses a matching score based on matching said first image and second image, wherein matching is based on said obtained DSM data and said hypothetical camera pose; and
determine the first camera pose based on the matching score of the at least one set of hypothetical camera poses.

In some examples, said obtained DSM data comprises predetermined DSM data.

In some examples of the system 300, the set of sensors 310 comprise pose change tracking means arranged to estimate changes in pose over time. In some of these examples said pose change tracking means comprise an inertial navigation system (INS), an inertial measurement unit (IMU), and/or a system utilizing a series of images, lidar and/or radar measurements to track pose change.

In some examples of the system 300, the set of sensors 310 comprise an inertial navigation system, INS, 312, and wherein the computer 320 is arranged to determine the relative pose difference between said first pose and said second pose based on navigation information from the INS 312.

In some examples of the system 300, the set of sensors 310 is arranged to obtain pose information for said at least first pose and/or said second pose, wherein pose information comprises a pose, a position, pitch information, roll information, and/or a bearing; and wherein the computer 320 is arranged to determine at least one set of hypothetical camera poses based on said pose information.

In some examples of the system 300, the set of sensors 310 comprise bearing means 314 arranged to measure and provide at least one bearing for the relative pose difference and/or the first camera pose, and/or the second camera pose. Obtaining a bearing, or even a rough bearing estimate, may significantly improve determining sets of hypothetical poses and/or the first pose by reducing the number of degrees of freedom.

In some examples of the system 300, the set of sensors 310 comprise a rangefinder 313 arranged to determine a distances to at least part of the field of view of said at least one camera. In some examples, the computer 320 is arranged to calculate said matching score based on said determined distance. Utilizing obtaining distance information for matching images may improve the fidelity in matching images, thereby improving the accuracy of the determined matching score.

In some examples of the system 300, the set of sensors 310 comprise at least two cameras, and said set of sensors 310 is arranged to simultaneously capture at least two images with at least partial overlap. In some of these examples, the set of sensors 310 comprises cameras mounted on at least two camera platforms, such as flying platforms or drones, wherein the set of sensors 310 is arranged such that the relative pose difference may be obtained by the computer 320.

In another example of the system 300, the set of sensors 310 comprises at least two cameras, wherein the computer 320 is arranged to obtain the relative pose difference between said first pose and said second pose based on the relative pose of said at least two cameras. Systems comprising a plurality of cameras with known relative pose, such as an aircraft with two cameras mounted far apart or two cameras on different aircrafts, may allow the INS 312 to be omitted, however, omitting the INS 312 may limit the system's ability to match images captured at different points in time while moving. Some examples of the system 300 comprise the INS 312 and the at least two cameras, wherein the computer 320 is arranged to determine the relative pose difference based on the relative pose of said at least two cameras and navigation information from the INS 312. Such an example system may simultaneously capture two images two times while moving, whereby the relative pose difference between images in each simultaneously captured pair is defined by the camera orientations, while the relative pose difference between the pairs is defined by navigation information from the INS 312.

It is to be understood that the term “the relative pose of said at least two cameras” is not limited to a static relative pose overtime, such as between two cameras rigidly mounted on one rigid body. As long as the system 300 is able to determine the relative pose of said at least two cameras, then the cameras may be gimbal mounted, attached to actuators, and/or mounted on a separate bodies.

In some examples of the system 300, the computer 320 is arranged to obtain at least one camera calibration for the set of sensors 310, and the computer 320 is arranged to calculate the matching score for each set of hypothetical camera poses based on said at least one camera calibration. Typically, camera calibration is known prior to image capture.

In some examples of the system 300, said system 300 is comprised in a flying platform. In some of these examples, the flying platform is an aircraft or an unmanned aerial vehicles, such as a drone.

In some examples the system 300, said system 300 is comprised in a watercraft.

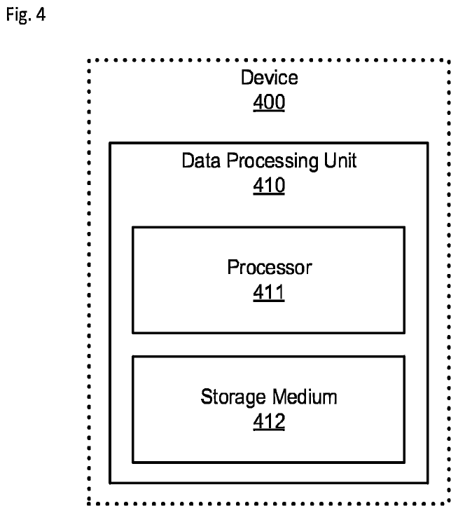

FIG. 4 schematically depicts a data processing unit comprising a computer program product for determining a pose. FIG. 4 depicts a data processing unit comprising a computer program product comprising a non-transitory computer-readable storage medium 412. The non-transitory computer-readable storage medium 412 having thereon a computer program comprising program instructions. The computer program is loadable into a data processing unit 410 and is configured to cause a processor 411 to carry out the method for determining a pose in accordance with the description of FIG. 1.

The data processing unit 410 may be comprised in a device 400. In some examples, the device 400 is the computer and/or memory storage comprised in system for determining a pose accordance with the description of FIG. 3.

The device 400 may be a computer and/or control circuitry.

The device 400 may be comprised in a vehicle and/or a land vehicle.

The device 400 may be comprised in an aircraft.

The device 400 may be comprised in a watercraft.

The device 400 may be part of a system for determining a pose of a vehicle.

The device 400 may be part of a system for determining a pose of an aircraft.

1-14. (canceled)

15. A computer implemented method for determining a pose, the method (100) comprising the steps of:
capturing (110), utilizing at least one camera (311), at least a first image (220) at a first pose and a second image (230) at a second pose;
obtaining (120) digital surface model, DSM, data (210), wherein said DSM data (210) represents a part of Earth's surface corresponding to said first pose and said second pose;
determining (130) at least one set of hypothetical camera poses, wherein each set of hypothetical camera poses is a candidate for the first and the second poses;
calculating (140) a matching score for each set of hypothetical camera poses based on matching said first image (220) and second image (230), wherein matching is based on said obtained DSM data (210) and said set of hypothetical camera poses; and
determining (150) the first pose based on the matching score of the at least one set of hypothetical camera poses.

16. The method according to claim 15, wherein:
capturing (110) the first image (220) and the second image (230) comprises obtaining a relative pose difference between said first pose and said second pose; and
determining (130) at least one set of hypothetical camera poses is based on said relative pose difference.

17. The method according to claim 16, wherein obtaining the relative pose difference between the first pose and the second pose comprises determining the relative pose difference utilizing navigation information obtained from pose change tracking means.

18. The method according to claim 17, wherein pose change tracking means comprise an inertial navigation system, an inertial measurement unit, and/or a system utilizing a series of images, lidar and/or radar measurements to track pose change.

19. The method according to claim 15, wherein:
capturing (110) the first image (220) and the second image (230) comprises obtaining pose information for said at least first pose and/or said second pose, wherein pose information comprises a pose, a position and/or a bearing; and
determining (130) at least one set of hypothetical camera poses is based on said pose information.

20. The method according to claim 19, wherein matching said first image (220) and said second image (230) is based on said pose information.

21. The method according to claim 15, wherein determining (130) at least one set of hypothetical camera poses comprises determining at least two sets of hypothetical camera poses.

22. The method according to claim 21, wherein determining (150) the first pose based on the matching scores of said at least two sets of hypothetical camera poses further comprises determining a probability density function for the determined first pose.

23. The method according to claim 15, wherein determining (130) at least one set of hypothetical camera poses comprises obtaining sensor information and/or a previously determined first pose, and wherein determining (130) at least one set of hypothetical camera poses is based on said sensor information and/or said previously determined first pose.

24. The method according to claim 15, wherein capturing (110) at least said first image (220) and said second image (230) comprises simultaneously capturing a plurality of the at least said first image (220) and said second image (230) utilizing at least two cameras (311).

25. A computer program product comprising a non-transitory computer-readable storage medium (412) having thereon a computer program comprising program instructions, the computer program being loadable into a processor (411) and configured to cause the processor (411) to perform the method (100) for determining a pose according to claim 15.

26. A system for determining a pose of a camera, the system (300) comprising:
a set of sensors (310),
a computer (320), and
a memory storage (330),
wherein:
the set of sensors (310) comprising at least one camera (311) and pose change tracking means arranged to estimate change in pose over time, and
said computer (320) is configured to:
control said at least one camera (311) to capture at least a first image (220) at a first pose and a second image (230) at a second pose;
determine a relative pose difference between said first pose and said second pose based on navigation information obtained from said pose change tracking means;
obtain digital surface model, DSM, data (210) from said memory storage (330), wherein said DSM data (210) corresponds to a part of Earth's surface corresponding to said first pose and said second pose,
determine at least one set of hypothetical camera poses, wherein each set of hypothetical camera poses is a candidate for the first and the second poses;
calculate a matching score for each set of hypothetical camera poses based on matching said first image (220) and second image (230), wherein matching is based on said obtained DSM data (210) and said set of hypothetical camera poses; and
determine the first pose based on the matching score of the at least one set of hypothetical camera poses.

27. The system according to claim 26, wherein the set of sensors (310) comprises at least two cameras, and wherein said set of sensors (310) is arranged to simultaneously capture at least two images with at least partial overlap.

28. The system according to claim 26, wherein pose change tracking means comprise an inertial navigation system (INS), an inertial measurement unit (IMU), and/or a system utilizing a series of images, lidar and/or radar measurements to track pose change.
